(19) United States
(12) Patent Application Publication
(10) Pub. No.: US 2014/0162520 A1
(43) Pub. Date: Jun. 12, 2014

(54) WATER-PROOF COATING SYSTEM FOR REFLECTING SOLAR RADIATION AND WATER-BORNE COATING FOR FORMING DECORATIVE AND REFLECTIVE LAYER IN COATING SYSTEM

(71) Applicants: Yunchuan She, Shanghai (CN); Congxiao Wang, Shanghai (CN); Timothy Marc Handyside, Saffron Walden (GB)

(72) Inventors: Yunchuan She, Shanghai (CN); Congxiao Wang, Shanghai (CN); Timothy Marc Handyside, Saffron Walden (GB)

(73) Assignee: CONSTRUCTION RESEARCH & TECHNOLOGY GMBH, Trostberg (DE)

(21) Appl. No.: 14/236,281

(22) PCT Filed: Aug. 5, 2011
(86) PCT No.: PCT/CN2011/078082

§ 371 Date: Jan. 30, 2014

(51) Int. Cl. C09D 5/33

(52) U.S. Cl. CPC C09D 5/004
USPC 442/327; 522/113; 522/81; 522/130; 428/523; 428/339; 428/461; 428/489

(57) ABSTRACT

A water-proof coating system for reflecting solar radiation, which comprises optionally a base layer on a substrate and a reinforcing layer on the base layer; a white reflective and water-proof layer on the substrate or on the reinforcing layer; and a decorative and reflective layer on the white reflective and water-proof layer; wherein the decorative and reflective layer comprises colored infrared-reflective pigments. Water-borne coatings for forming a decorative and reflective layer in the coating system, which comprise acrylic polymers, colored infrared-reflective pigments and UV cross-linking agents. Said coating system can reflect solar radiation with high efficiency and effectively prevent water from penetrating through; has strong stain resistance and good weather resistance; has strong adhesion to various substrates; and also offers diversified colors for choosing. Said water-borne coatings can be applied easily, and are environment friendly.

### TECHNICAL FIELD

Present invention relates to a water-proof coating system for reflecting solar radiation and also water-borne coatings for forming the decorative and reflective layer in said coating system comprising acrylic polymers, colored infrared-reflective pigment and UV cross-linking agents.

### BACKGROUND ART

Solar radiation arriving at the earth surface provides necessary conditions for the existence and daily life of human beings, at the same time it also inevitably cause the interior temperature of buildings such as houses, offices and factories to rise, which resulting from the heat absorbance by its exterior surface from solar radiation. To lower the interior temperature of buildings, it is required to use refrigerating facilities such as shower devices, air conditionings and ventilating devices, and consume a great deal of energy.

Application of coatings, which can effectively reflect solar radiation, onto the exterior surface of buildings such as houses, offices and factories is an important method for lowering its interior temperature. Apparently, the reflectivity of coating towards solar radiation is higher, effect thereof for lowering the interior temperature of buildings is better, which further prolongs the service life of buildings evidently.

American patent U.S. Pat. No. 5,434,009 disclosed a roofing laminate comprising: a first layer forming an asphaltic base for the laminate; at least a second layer adhered to the first layer; the second layer including an acrylic polymer in an amount sufficient to form a continuous film upon application to the base asphaltic layer and a cross-linking promoting metal complex within the acrylic polymer; and a third layer adhered to the second layer, the third layer being formed of acrylic polymer and including an ultraviolet light blocking agent.

European patent application EP 1160299 A1 disclosed an improved exterior elastomeric coating composition, said coating composition comprises an organic binder, having a Tg less than −20° C., and at least one inorganic additive, wherein said improvement comprises replacing at least a part of said at least one inorganic additive with a solid particulate organic polymer having a Tg greater than 70° C.

Chinese patent application CN 101319121 A disclosed multi-functional, highly efficient and thermally insulating coatings, said coatings comprise 16 to 20% by weight rutile titanium dioxide, 3 to 5% by weight infrared-reflective power and 35 to 40% by weight elastic acrylic emulsion.

Chinese patent application CN 101343453 A disclosed water-borne, elastic, thermally insulating and energy-saving coatings, said coatings comprise 200 to 250 parts by weight elastic emulsion, 20 to 35 parts by weight far infrared-reflective power and 40 to 60 parts by weight titanium dioxide. During the course of application of said water-borne, elastic, thermally insulating and energy-saving coatings onto walls, first a primer is coated, then said water-borne, elastic, thermally insulating and energy-saving coatings are coated 2 or 3 times, last a transparent finish is coated.

American patent application US 2005261407 A1 disclosed a top coating composition of high energy efficacy, reflectance, and durability comprising a mixture of a polymeric binder, a polymeric carrier and an effective amount of a pigment that is capable of providing a coating that has an initial energy efficacy rating greater than or equal to 0.65 for a low-sloped roof, or an initial energy efficacy greater than or equal to 0.25 for a steep-sloped roof; wherein said composition is applied in-plant during manufacture of roofing membranes.

American patent application US 2007054129 A1 disclosed a roofing membrane with high solar heat reflectance, the roofing membrane comprising a bituminous base sheet; a tie-layer comprising a reinforcement material; and a solar heat-reflective upper layer.

Above mentioned prior products can't simultaneously reflect solar radiation and prevent water from penetrating through effectively, especially can't do so effectively for a long term, and regarding their colors white predominates over others. Therefore, they can't meet the demands of customers effectively.

### Contents of Invention

In consideration of above mentioned prior arts, the inventors have conducted an extensive and intensive investigation in the technical filed of water-proof coating for reflecting solar radiation, aiming at obtaining a coating or coating system which can high-efficiently reflect solar radiation and effectively prevent water from penetrating through. It is found that above mentioned object can be achieved by a coating system comprising a white reflective and water-proof layer and a decorative and reflective layer on the reflective and water-proof layer, wherein the decorative and reflective layer comprises colored infrared-reflective pigments. It is just above mentioned findings on which the inventors rely to complete present invention.

Present invention aims to provide a water-proof coating system for reflecting solar radiation.

Present invention further aims to provide water-borne coatings for forming the decorative and reflective layer in a coating system.

In one aspect, present invention provides a water-proof coating system for reflecting solar radiation, said coating system comprises:
optionally a base layer on a substrate and a reinforcing layer on the base layer;
a white reflective and water-proof layer on the substrate or on the reinforcing layer; and
a decorative and reflective layer on the white reflective and water-proof layer;
wherein the decorative and reflective layer comprises colored infrared-reflective pigments.

In a further one aspect, present invention provides water-borne coatings for forming the decorative and reflective layer in the coating system, said water-borne coatings comprise:
acrylic polymers;
colored infrared-reflective pigments; and
UV cross-linking agents.

The coating system according to present invention is of high reflectivity towards solar radiation and is effectively water-proof; has strong stain resistance and good weather resistance, therefore preventing high reflectivity of said coating system towards solar radiation from apparently declining over time; has strong adhesion to various substrates, thus producing a result that during its application no primer is needed any longer; establishes a good balance of tensile strength and elongation at break between the white reflective and water-proof layer and the decorative and reflective layer; and also offers diversified colors for choosing. Water-borne coatings for forming said coating system can be applied easily, and are environment friendly.

These and other objects, characters and advantages of present invention will be apparent to a person skilled in the art after considering present invention as a whole.

### DESCRIPTIONS OF DRAWINGS

FIG. 1 shows a coating system according to one embodiment of present invention.

FIG. 2 shows a coating system according to another one embodiment of present invention.

### SPECIFIC MODE FOR CARRYING OUT THE INVENTION

According to one embodiment of present invention, the water-proof coating system for reflecting solar radiation comprises a white reflective and water-proof layer on a substrate; and a decorative and reflective layer on the white reflective and water-proof layer; wherein the decorative and reflective layer comprises colored infrared-reflective pigments. Said coating system for example is suitable for jointless areas of a roof.

According to another one embodiment of present invention, the water-proof coating system for reflecting solar radiation comprises a base layer on a substrate; a reinforcing layer on the base layer; a white reflective and water-proof layer on the reinforcing layer; and a decorative and reflective layer on the white reflective and water-proof layer; wherein the decorative and reflective layer comprises colored infrared-reflective pigments. Said coating system for example is suitable for joint areas of a roof, or for other substrates which requiring reinforcement due to its insufficient mechanical strength.

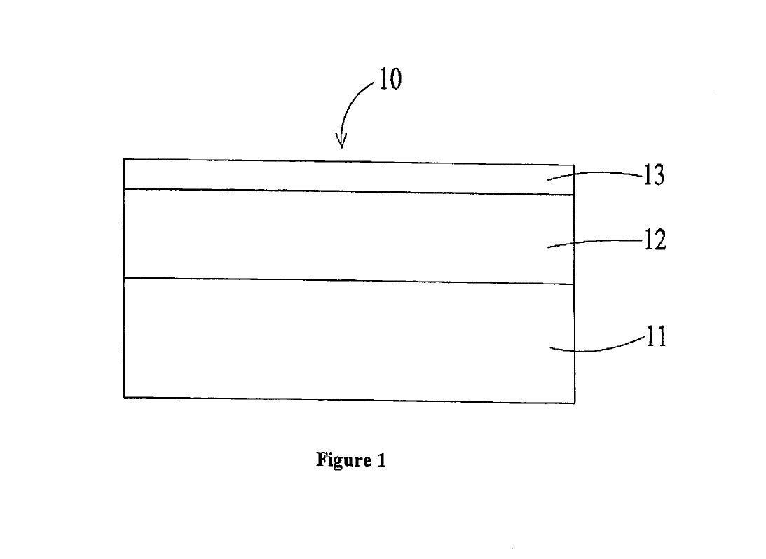

FIG. 1 schematically shows coating system 10 intended for jointless areas of a roof according to present invention, which comprises white reflective and water-proof layer 12 on substrate 11; and decorative and reflective layer 13 on white reflective and water-proof layer 12.

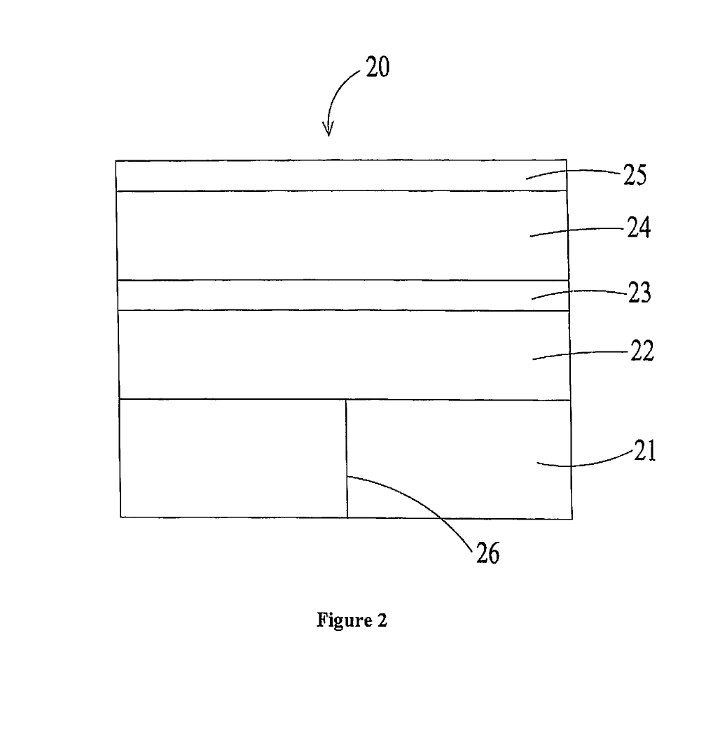

FIG. 2 schematically shows coating system 20 intended for joint 26 of a roof according to present invention, which comprises base layer 22 on substrate 21; reinforcing layer 23 on base layer 22; white reflective and water-proof layer 24 on reinforcing layer 23; and decorative and reflective layer 25 on white reflective and water-proof layer 24.

By comparison of FIG. 1 with FIG. 2, it can be seen that depending on different application environments thereof, the base layer on a substrate and the reinforcing layer on the base layer both are optional.

The coating system according to present invention is suitable for various substrates, such as metal substrate, colored steel plate, concrete, asphaltic substrate or PVC substrate.

The optional base layer in the coating system according to present invention may be any suitable base layers having good adhesion to the substrate and known by a person skilled in the art. For example it can be formed from polyester coatings or polyurethane coatings. In consideration of convenient application, the base layer is made up by a same material as that of the white reflective and water-proof layer. For example, in case of the white reflective and water-proof layer is formed from water-borne coatings as set forth below comprising acrylic polymers and white infrared-reflective pigments, the base layer also is formed from said water-borne coatings. In this case, from the viewpoint of saving costs, the base layer also can be formed from said water-borne coatings but without white infrared-reflective pigments, especially titanium dioxide.

The optional reinforcing layer in the coating system according to present invention is used to reinforce the mechanical strength of for example joints of a roof, which preferably is non-woven fabrics of fibers. Said fibers for example can be natural fibers, such as wood and cotton; synthetic material fibers, such as polyester, nylon, polypropylene, polyvinylidene fluoride, ethylene/tetrafluoroethylene copolymer, polyethylene terephthalate, polypropylene terephthalate, polybutylene terephthalate, polyethylene naphthalate, poly(meth)acrylates, polyetherketone; inorganic material fibers, such as glass fiber or metallic fiber; or combinations thereof. The reinforcing layer preferably is non-woven fabrics of synthetic material fiber, glass fiber or combination thereof, more preferably is non-woven fabrics of polyester fiber or glass fiber. Before the base layer is completely solidified, non-woven fabrics of fibers are lain down onto the base layer to form said reinforcing layer.

In the coating system according to present invention, in case of not using the base layer and reinforcing layer, the white reflective and water-proof layer is directly on the substrate; in case of using the base layer and reinforcing layer, the white reflective and water-proof layer is on the reinforcing layer.

The white reflective and water-proof layer in the coating system according to present invention plays a role of preventing water such as rain water from penetrating through, meanwhile it also can reflect solar radiation effectively, especially infrared radiation. For this reason, the white reflective and water-proof layer in the coating system according to present invention comprises white infrared-reflective pigments. White infrared-reflective pigments preferably are titanium dioxide, zinc oxide, zinc sulfide or mixtures thereof, more preferably are rutile titanium dioxide. In the white reflective and water-proof layer, white infrared-reflective pigments are 1 to 50% by weight based on the white reflective and water-proof layer, preferably are 2 to 20% by weight.

The white reflective and water-proof layer in the coating system according to present invention is formed from coatings comprising acrylic polymers and white infrared-reflective pigments, preferably from water-borne coatings comprising acrylic polymers and white infrared-reflective pigments.

Acrylic polymers for example can be acrylic homopolymers or copolymers or mixtures thereof, such as homopolymers of acrylic acid, acrylate, methacrylic acid or methacrylate; or acrylate/acrylate copolymers, methacrylate/methacrylate copolymer; or copolymers formed from two or more of acrylic acid, acrylate, methacrylic acid, methacrylate and styrene; or mixtures thereof. Acrylic polymers preferably are acrylate/acrylate copolymers, methacrylate/methacrylate copolymers, acrylate/styrene copolymers, methacrylate/styrene copolymers, acrylate/methacrylate/styrene copolymers or mixtures thereof. Advantageously, acrylic polymers are C1-8 alkyl acrylate/C1-8 alkyl acrylate copolymers, C1-8 alkyl methacrylate/C1-8 alkyl methacrylate copolymers, C1-8 alkyl acrylate/styrene copolymers, C1-8 alkyl methacrylate/styrene copolymers, C1-8 alkyl acrylate/C1-8 alkyl methacrylate/styrene copolymers or mixtures thereof; preferably are C1-4 alkyl acrylate/C1-4 alkyl acrylate copolymers, C1-4 alkyl methacrylate/C1-4 alkyl methacrylate copolymers, C1-4 alkyl acrylate/styrene copolymers, C1-4 alkyl methacrylate/styrene copolymers, C1-4 alkyl acrylate/C1-4 alkyl methacrylate/styrene copolymers or mixtures thereof. More particularly, acrylic polymers for example can be butyl acrylate/styrene copolymer or butyl acrylate/methyl methacrylate/styrene copolymer.

Acrylic polymers are commercially available, and also can be synthesized by conventional processes known by a person skilled in the art. It can be used for example in form of polymeric solid particles, and also can be used in said water-borne coatings in form of an aqueous polymeric dispersion.

Particular examples of commercially available aqueous dispersions of acrylic polymers include but not limit to Acronal® Flex SC 138 ap, Acronal® 405 ap, Acronal® GS 409 ap, Acronal® S 533 and Acronal® NX 3587 from BASF; Maincote™ PR-71K, PRIMAL™ EC-1791 and Elstine 8556 from Dow Chemical Company; Revacryl 100 and Revacryl 245 from Synthomer.

Preferably, a mixture of two or more of acrylic polymers, such as a mixture of PRIMAL™ EC-1791 and Acronal® NX 3587 is used in said water-borne coatings.

Acrylic polymers are 22.5 to 32.5% by weight based on the total weight of water-borne coatings.

White infrared-reflective pigments preferably are titanium dioxide, zinc oxide, zinc sulfide or mixtures thereof. Titanium dioxide includes rutile titanium dioxide and anatase titanium dioxide, and is commercially available, or else can be prepared by conventional processes known by a person skilled in the art. White infrared-reflective pigments more preferably are rutile titanium dioxide.

In connection with pigments, said water-borne coatings comprise only white infrared-reflective pigments, preferably comprise only titanium dioxide, zinc oxide, zinc sulfide or mixtures thereof, for example comprise only rutile titanium dioxide, since the reflective and water-proof layer is white.

White infrared-reflective pigments can have a particle size of for example 0.2 to 0.3 μm.

White infrared-reflective pigments are 0.5 to 25% by weight based on the total weight of water-borne coatings, preferably are 1 to 10% by weight.

In addition to acrylic polymers and white infrared-reflective pigments, above said water-borne coatings can also comprise other components as follows:

Dispersants, such as TEGO® Dispers 715 W and TEGO® Wet KL 245 from Evonik Tego Chemie GmbH;

Defoaming agents, such as TEGO® Foamex 1488 from Evonik Tego Chemie GmbH; BYK® 021 and BYK® 024 from BYK Additives & Instrument; FOAMASTER® 8034 and FOAMASTER® NXZ from Cognis;

Fillers, such as barium sulfate, calcium carbonate, talc powder, kaolin, mica powder, aluminium silicate;

Microbiocides, such as DeuAdd MB-11 and DeuAdd MB-16 from Elementis Specialties; SKANE™ M-8 from Dow Chemical Company;

Thickeners, such as HEC ER5200 and RM-2020 from Dow Chemical Company; BYK® 420 and BYK® 428 from BYK Additives & Instrument; TEGO® ViscoPlus 3030 from Evonik Tego Chemie GmbH; and

pH modifiers, such as aqueous ammonia; AMP-95 from Dow Chemical Company; NaOH.

The amount of above said other components in water-borne coatings is a conventional amount.

Above said water-borne coatings are prepared by mixing acrylic polymers, white infrared-reflective pigments, water and other optional components and then grinding; alternatively, by first mixing acrylic polymers, water and other optional components and grinding, and then blending the mixture resulting from grinding with white infrared-reflective pigments. During the course of said preparation, the final value of water-borne coatings is adjusted within the range of 7.5 to 10.5 by means of controlling the amount of modifier used therein.

Said water-borne coatings can be applied onto the substrate or reinforcing layer via conventional means in the art such as knife coating, roller coating, brushing, spraying; and then cured through self-crosslinking under environmental conditions to obtain the white reflective and water-proof layer.

In case of not using the base layer and reinforcing layer, the white reflective and water-proof layer has a dry film thickness of 0.2 to 1.5 mm, preferably 0.4 to 0.6 mm. In case that the base layer and reinforcing layer are used as well as the base layer is made up by a same material as that of the white reflective and water-proof layer, the sum of thicknesses of dry film of the base layer, the reinforcing layer and dry film of the white reflective and water-proof layer is 1 to 2 mm.

The white reflective and water-proof layer has a tensile strength of 1 to 4 MPa, and an elongation at break of 100 to 400%.

Meanwhile, the white reflective and water-proof layer formed from above mentioned water-borne coatings has strong adhesion to various substrates, for example generally is 300-2000 N/m, thus producing a result that during its application no primer is needed any longer.

The decorative and reflective layer in the coating system according to present invention has an effect of decorating, for example of providing a colored coating system such as grey or bottle green, meanwhile it also can reflect solar radiation effectively, especially infrared radiation. For this reason, the decorative and reflective layer in the coating system according to present invention comprises colored infrared-reflective pigments.

On the basis of their specific colors, infrared-reflective pigments can be classified into white infrared-reflective pigments and colored infrared-reflective pigments, wherein colored infrared-reflective pigments mean the color thereof may be any one aside from white, such as black infrared-reflective pigment.

Colored infrared-reflective pigments preferably are chrome iron oxides, cobalt aluminum oxides, cobalt chrome aluminum oxides, manganese antimony titanium oxides, iron zinc titanium oxides, iron aluminum titanium oxides, chrome antimony titanium oxides, nickel antimony titanium oxides, cobalt chrome zinc titanium oxides, cobalt nickel zinc titanium oxides, iron chrome zinc titanium oxides, cobalt chrome magnesium zinc aluminium oxides or mixtures thereof. With regard to grey decorative and reflective layer, colored infrared-reflective pigments are 2 to 30% by weight based on the decorative and reflective layer. With regard to bottle green decorative and reflective layer, colored infrared-reflective pigments are 2 to 20% by weight based on the decorative and reflective layer.

The decorative and reflective layer in the coating system according to present invention is formed from coatings comprising acrylic polymers, colored infrared-reflective pigments and UV cross-linking agents, preferably from water-borne coatings comprising acrylic polymers, colored infrared-reflective pigments and UV cross-linking agents.

To this end, present invention further provides water-borne coatings for forming the decorative and reflective layer in the coating system, said water-borne coatings comprise:
acrylic polymers;
colored infrared-reflective pigments; and
UV cross-linking agents.

Acrylic polymers for example can be acrylic homopolymers or copolymers or mixtures thereof, such as homopolymers of acrylic acid, acrylate, methacrylic acid or methacrylate; or acrylate/acrylate copolymers, methacrylate/methacrylate copolymer; or copolymers formed from two or more of acrylic acid, acrylate, methacrylic acid, methacrylate and styrene; or mixtures thereof. Acrylic polymers preferably are acrylate/acrylate copolymers, methacrylate/methacrylate copolymers, acrylate/styrene copolymers, methacrylate/styrene copolymers, acrylate/methacrylate/styrene copolymers or mixtures thereof. Advantageously, acrylic polymers are C1-8 alkyl acrylate/C1-8 alkyl acrylate copolymers. C1-8 alkyl methacrylate/C1-8 alkyl methacrylate copolymers, C1-8 alkyl acrylate/styrene copolymers, C1-8 alkyl methacrylate/styrene copolymers, C1-8 alkyl acrylate/C1-8 alkyl methacrylate/styrene copolymers or mixtures thereof; preferably are C1-4 alkyl acrylate/C1-4 alkyl acrylate copolymers, C1-4 alkyl methacrylate/C1-4 alkyl methacrylate copolymers, C1-4 alkyl acrylate/styrene copolymers, C1-4 alkyl methacrylate/styrene copolymers, C1-4 alkyl acrylate/C1-4 alkyl methacrylate/styrene copolymers or mixtures thereof. More particularly, acrylic polymers for example can be butyl acrylate/methyl methacrylate/styrene copolymer.

Acrylic polymers are commercially available, and also can be synthesized by conventional processes known by a person skilled in the art, it can be used for example in form of polymeric solid particles, and also can be used in said water-borne coatings in form of an aqueous polymeric dispersion.

Particular examples of commercially available aqueous dispersions of acrylic polymers include but not limit to Acronal® Flex SC 138 ap, Acronal® 405 ap, Acronal® GS 409 ap, Acronal® S 533 and Acronal® NX 3587 from BASF; PRIMAL™ EC-1791 from Dow Chemical Company; Revacryl 100 from Synthomer.

Preferably, a mixture of two or more of acrylic polymers, such as a mixtures of Acronal® S 533 and Revacryl 100 is used in said water-borne coatings.

Acrylic polymers are 20 to 35% by weight based on the total weight of water-borne coatings, preferably are 22.5 to 32.5% by weight.

Colored infrared-reflective pigments preferably are chrome iron oxides, cobalt aluminum oxides, cobalt chrome aluminum oxides, manganese antimony titanium oxides, iron zinc titanium oxides, iron aluminum titanium oxides, chrome antimony titanium oxides, nickel antimony titanium oxides, cobalt chrome zinc titanium oxides, cobalt nickel zinc titanium oxides, iron chrome zinc titanium oxides, cobalt chrome magnesium zinc aluminium oxides or mixtures thereof. For example, the particular examples thereof can be Xfast® Black EH 0408 (0095) from BASF, Black 30C933 and Black 30C965 from Shepherd Color Company.

According to desired different colors of the decorative and reflective layer, the amount of colored infrared-reflective pigments in above mentioned water-borne coatings can vary within a relatively wide range. With regard to grey decorative and reflective layer, the amount of colored infrared-reflective pigments in above mentioned water-borne coatings is 1 to 15% by weight. With regard to bottle green decorative and reflective layer, the amount of colored infrared-reflective pigments in above mentioned water-borne coatings is 1 to 10% by weight.

In addition to colored infrared-reflective pigments, white infrared-reflective pigments can also used in said water-borne coatings. For example, in case that the decorative and reflective layer is grey, said water-borne coatings comprise titanium dioxide and black infrared-reflective pigments.

In addition to above mentioned colored infrared-reflective pigments, water-borne coatings for forming the decorative and reflective layer in the coating system also can comprise other pigments such as iron oxide red and iron oxide yellow due to such reasons as color matching and hiding power of pigments. According to desired different colors of the decorative and reflective layer, the amount of other pigments in water-borne coatings can be determined by a person skilled in the art.

Any suitable UV cross-linking agents can be used in water-borne coatings for forming the decorative and reflective layer, and UV cross-linking agents used preferably are benzophenone, benzophenones substituted by C1-3 alkyl or mixtures thereof. Particular examples of benzophenones substituted by C1-3 alkyl include but not limit to 2-methyl benzophenone, 3-methyl benzophenone, 4-methyl benzophenone, 4-ethyl benzophenone, 4-propyl benzophenone, 4-methyl-4′-methyl benzophenone, 4-methyl-4′-ethyl benzophenone, 4-ethyl-4′-ethyl benzophenone. A particular example of UV cross-linking agents used is Esacure TZM from Lamberti Spa, which consisting of about 50% benzophenone and about 50% 4-methyl benzophenone. UV cross-linking agents are 0.1 to 2% by weight based on the total weight of water-borne coatings, preferably are 0.3 to 1.5% by weight.

In addition to acrylic polymers, colored infrared-reflective pigments and UV cross-linking agents, above said water-borne coatings can also comprise other components as follows:

Dispersants, such as TEGO® Dispers 715 W and TEGO® Wet KL 245 from Evonik Tego Chemie GmbH; the amount thereof is 0.2 to 1% by weight based on water-borne coatings;

Defoaming agents, such as TEGO® Foamex 1488 from Evonik Tego Chemie GmbH; BYK® 021 and BYK® 024 from BYK Additives & Instrument; FOAMASTER® 8034 and FOAMASTER® NXZ from Cognis; the amount thereof is 0.2 to 1% by weight based on water-borne coatings;

Fillers, such as barium sulfate, calcium carbonate, talc powder, kaolin, mica powder, aluminium silicate; the amount thereof is 20 to 40% by weight based on water-borne coatings;

Microbiocides, such as DeuAdd MB-11 and DeuAdd MB-16 from Elementis Specialties; SKANE™ M-8 from Dow Chemical Company; the amount thereof is 0.1 to 0.5% by weight based on water-borne coatings;

Thickeners, such as HEC ER5200 and RM-2020 from Dow Chemical Company; BYK® 420 and BYK® 428 from BYK Additives & Instrument; TEGO® ViscoPlus 3030 from Evonik Tego Chemie GmbH; the amount thereof is 0.2 to 1.5% by weight based on water-borne coatings; and

pH modifiers, such as aqueous ammonia; AMP-95 from Dow Chemical Company; NaOH; the amount thereof depends on desired final pH value of water-borne coatings, and normally is 0.1 to 1% by weight based on water-borne coatings.

Above said water-borne coatings are prepared by mixing acrylic polymers, colored infrared-reflective pigments, optional white infrared-reflective pigments, optional other pigments, UV cross-linking agents, water and other optional components and then grinding; alternatively, by first mixing acrylic polymers, UV cross-linking agents, water and other optional components and grinding, and then blending the mixture resulting from grinding with colored infrared-reflective pigments, optional white infrared-reflective pigments and optional other pigments.

Said water-borne coatings can be applied onto the white reflective and water-proof layer via conventional means in the art such as knife coating, roller coating, brushing, spraying; and then UV cured under environmental conditions to obtain the decorative and reflective layer.

The decorative and reflective layer has a dry film thickness of 0.02 to 0.3 mm, preferably 0.08 to 0.1 mm.

The decorative and reflective layer has a tensile strength of 1 to 4 MPa, and an elongation at break of 100 to 400%.

Meanwhile, the decorative and reflective layer formed from above mentioned water-borne coatings has strong stain resistance, generally exhibits a stain resistance of grade 2 or less in colorimetry; has good weather resistance, can successfully pass accelerated aging test of 1000 hours under xenon lamp without any notable changes; therefore prevents high reflectivity of said coating system towards solar radiation from apparently declining over time.

The coating system according to present invention is suitable for roof and walls of such buildings as houses, offices and factories, especially those in areas of high temperature and long rainy season.

### EXAMPLES

Present invention will be particularly illustrated below by reference to examples, but which examples are not intended to limit the protection scope of present invention anyway.

Total solar radiation reflectivity of the coating system is tested according to GJB 2502-1996 (210); water impermeability of the coating system, tensile strength and elongation at break of the white reflective and water-proof layer and the decorative and reflective layer are tested according to GB/T 16777-1997; adhesion of the coating system to substrate is tested according to GB/T 2790-1995; stain resistance of the coating system is tested according to GB/T 9780; and weather resistance of the coating system is tested according to GB/T 1865-1997.

Titanium dioxide used in below examples and comparative examples has a particle size of 0.2 to 0.3 μm.

### Examples 1

The formulation of water-borne coatings for forming a white reflective and water-proof layer in the coating system is shown below in table 1, which water-borne coatings have a pH value of 9.5.

TABLE 1
water-borne coatings 1 for forming a white
reflective and water-proof layer

| component | amount(kg) |
|---|---|
| water | 91.6 |
| PRIMAL ™ EC-1791(acrylic polymer) | 264.0 |
| Acronal ® NX 3587(acrylic polymer) | 264.0 |
| titanium dioxide(white infrared-reflective | 20.0 |
| pigment) | |
| ZnO(white infrared-reflective pigment) | 10.0 |
| TEGO ® WET KL 245(dispersant) | 5.0 |
| BYK ® 024(defoaming agent) | 4.0 |
| calcium carbonate(filler) | 165.0 |
| mica powder(filler) | 165.0 |
| SKANE ™ M-8(microbiocide) | 1.5 |
| RM-2020(thicker) | 4.0 |
| TEGO ® ViscoPlus 3030(thicker) | 1.2 |
| BYK ® 428(thicker) | 2.7 |
| aqueous ammonia (pH modifier) | 2.0 |

The formulation of waterborne coatings for forming a grey decorative and reflective layer in the coating system is shown below in table 2.

TABLE 2
water-borne coatings 2 for forming a
grey decorative and reflective layer

| component | amount(kg) |
|---|---|
| water | 82.5 |
| Acronal ® S 533 (acrylic polymer) | 155.5 |
| Revacryl 100(acrylic polymer) | 362.5 |
| titanium dioxide(white infrared-reflective pigment) | 81.8 |
| Xfast ® Black EH 0408 (0095) (black infrared-reflective | 20.0 |
| pigment) | |
| TEGO ® Dispers 715 W(dispersant) | 5.0 |
| FOAMASTER ® 8034(defoaming agent) | 7.1 |
| calcium carbonate(filler) | 271.3 |
| SKANE ™ M-8(microbiocide) | 1.5 |
| Esacure TZM(UV curing agent) | 6.0 |
| RM-2020(thicker) | 2.5 |
| TEGO ® ViscoPlus 3030(thicker) | 0.8 |
| HEC ER5200(thicker) | 1.8 |
| AMP-95(pH modifier) | 2.0 |

At a temperature of 32° C. and a relative humidity of 20%, water-borne coatings 1 is sprayed in an amount of 0.82 kg/m² onto a colored steel plate (coated with polyester), and cured by self-crosslinking under environmental conditions to obtain a white reflective and water-proof layer having a dry film thickness of 400 μm; at a temperature of 32° C. and a relative humidity of 20%, water-borne coatings 2 is sprayed in an amount of 0.28 kg/m² onto the white reflective and water-proof layer, and UV cured under environmental conditions to obtain a grey decorative and reflective layer having a dry film thickness of 100 μm; thus obtaining coating system 1 according to present invention.

### Examples 2

The formulation of water-borne coatings for forming a white reflective and water-proof layer in the coating system is shown below in table 3, which water-borne coatings have a pH value of 9.5.

TABLE 3
water-borne coatings 3 for forming a white
reflective and water-proof layer

| component | amount(kg) |
|---|---|
| water | 139.6 |
| PRIMAL ™ EC-1791(acrylic polymer) | 240.0 |
| Acronal ® NX 3587(acrylic polymer) | 240.0 |
| titanium dioxide(white infrared-reflective | 30.0 |
| pigment) | |
| ZnO(white infrared-reflective pigment) | 10.0 |
| TEGO ® WET KL 245(dispersant) | 5.0 |
| BYK ® 024(defoaming agent) | 4.0 |
| calcium carbonate(filler) | 160.0 |
| mica powder(filler) | 160.0 |
| SKANE ™ M-8(microbiocide) | 1.5 |
| RM-2020(thicker) | 4.0 |
| TEGO ® ViscoPlus 3030(thicker) | 1.2 |
| BYK ® 428(thicker) | 2.7 |
| aqueous ammonia (pH modifier) | 2.0 |

The formulation of water-borne coatings for forming a bottle green decorative and reflective layer in the coating system is shown below in table 4.

TABLE 4
water-borne coatings 4 for forming a bottle
green decorative and reflective layer

| component | amount(kg) |
|---|---|
| water | 158.7 |
| Acronal ® 405 ap(acrylic polymer) | 142 |
| Acronal ® Flex SC 138 ap(acrylic polymer) | 318 |
| titanium dioxide(white infrared-reflective pigment) | 12.95 |
| Xfast ® Black EH 0408 (0095) (black infrared-reflective | 11.95 |
| pigment) | |
| iron oxide yellow(YL 1990^{a}) (yellow pigment) | 12.6 |
| chlorinated copper phthalocyanine (GN 8730^{a})(light | 32.5 |
| green pigment) | |
| TEGO ® Dispers 715 W(dispersant) | 5.2 |
| FOAMASTER ® 8034(defoaming agent) | 6.2 |
| calcium carbonate(filler) | 280.8 |
| DeuAdd MB-11(microbiocide) | 1.6 |
| Esacure TZM(UV curing agent) | 10.2 |
| RM-2020(thicker) | 2.6 |
| TEGO ® ViscoPlus 3030(thicker) | 0.8 |
| HEC ER5200(thicker) | 1.8 |
| AMP-95(pH modifier) | 2.1 |

^{a}from BASF, the same below.

At a temperature of 23° C. and a relative humidity of 50%, water-borne coatings 3 is sprayed in an amount of 0.82 kg/m² onto a colored steel plate (coated with polyester), and cured by self-crosslinking under environmental conditions to obtain a white reflective and water-proof layer having a dry film thickness of 400 μm; at a temperature of 23° C. and a relative humidity of 50%, water-borne coatings 4 is sprayed in an amount of 0.28 kg/m² onto the white reflective and water-proof layer, and UV cured under environmental conditions to obtain a bottle green decorative and reflective layer having a dry film thickness of 100 μm; thus obtaining coating system 2 according to present invention.

### Examples 3

The formulation of water-borne coatings for forming a white reflective and water-proof layer in the coating system is shown below in table 5, which water-borne coatings have a pH value of 9.5.

TABLE 5
water-borne coatings 5 for forming a white
reflective and water-proof layer

| component | amount(kg) |
|---|---|
| water | 91.6 |
| Acronal ® Flex SC 138 ap (acrylic polymer) | 528 |
| titanium dioxide(white infrared-reflective | 30.0 |
| pigment) | |
| TEGO ® WET KL 245(dispersant) | 5.0 |
| BYK ® 024(defoaming agent) | 4.0 |
| barium sulfate(filler) | 165.0 |
| mica powder( filler) | 165.0 |
| SKANE ™ M-8(microbiocide) | 1.5 |
| RM-2020(thicker) | 4.0 |
| TEGO ® ViscoPlus 3030(thicker) | 1.2 |
| BYK ® 428(thicker) | 2.7 |
| AMP-95 (pH modifier) | 2.0 |

Water-borne coatings for forming a bottle green decorative and reflective layer in the coating system is shown afore in table 4.

At a temperature of 32° C. and a relative humidity of 20%, water-borne coatings 5 is sprayed in an amount of 1 kg/m² onto a colored steel plate (coated with polyester), and cured by self-crosslinking under environmental conditions to obtain a white reflective and water-proof layer having a dry film thickness of 500 μm; at a temperature of 32° C. and a relative humidity of 20%, water-borne coatings 4 is sprayed in an amount of 0.56 kg/m² onto the white reflective and water-proof layer, and UV cured under environmental conditions to obtain a bottle green decorative and reflective layer having a dry film thickness of 200 μm; thus obtaining coating system 3 according to present invention.

### Comparative Example 1

Water-borne coatings for forming a white bottom coating in the comparative coating system is shown afore in table 1.

The formulation of water-borne coatings for forming a grey top coating in the comparative coating system is shown below in table 6.

TABLE 6
water-borne coatings 6 for forming a grey top coating

| component | amount(kg) |
|---|---|
| water | 91.6 |
| Acronal ® 405 ap (acrylic polymer) | 364.0 |
| Acronal ® Flex SC 138 ap (acrylic polymer) | 164.0 |
| titanium dioxide(white infrared-reflective | 29.0 |
| pigment) | |
| Xfast 0060^{b}(black pigment) | 1 |
| TEGO ® WET KL 245(dispersant) | 5.0 |
| BYK ® 024(defoaming agent) | 4.0 |
| barium sulfate(filler) | 165.0 |
| mica powder( filler) | 165.0 |
| SKANE ™ M-8(microbiocide) | 1.5 |
| RM-2020(thicker) | 4.0 |
| TEGO ® ViscoPlus 3030(thicker) | 1.2 |
| BYK ® 428(thicker) | 2.7 |
| AMP-95 (pH modifier) | 2.0 |

^{b}carbon black, from BASF, the same below.

At a temperature of 32° C. and a relative humidity of 20%, water-borne coatings 1 is sprayed in an amount of 0.82 kg/m² onto a colored steel plate (coated with polyester), and cured by self-crosslinking under environmental conditions to obtain a white bottom coating having a dry film thickness of 400 μm; at a temperature of 32° C. and a relative humidity of 20%, water-home coatings 6 is sprayed in an amount of 0.28 kg/m² onto the white bottom coating, and cured by self-crosslinking under environmental conditions to obtain a grey top coating having a dry film thickness of 100 μm; thus obtaining comparative coating system 1.

### Comparative Example 2

Water-borne coatings for forming a white bottom coating in the comparative coating system is shown afore in table 3.

The formulation of water-borne coatings for forming a bottle green top coating in the comparative coating system is shown below in table 7.

TABLE 7
water-borne coatings 7 for forming a bottle green top coating

| component | amount(kg) |
|---|---|
| water | 85.4 |
| Acronal ® 405 ap(acrylic polymer) | 161 |
| Acronal ® GS 409 ap (acrylic polymer) | 375.3 |
| Xfast ® 0060(black pigment) | 2.11 |
| iron oxide yellow(YL 1990) (yellow | 23.64 |
| pigment) | |
| chlorinated copper phthalocyanine (GN | 74.25 |
| 8730)(light green pigment) | |
| TEGO ® Dispers 715 W(dispersant) | 5.2 |
| FOAMASTER ® 8034(defoaming agent) | 6.2 |
| calcium carbonate(filler) | 323 |
| DeuAdd MB-11(microbiocide) | 1.6 |
| Esacure TZM(UV curing agent) | 6.2 |
| RM-2020(thicker) | 2.6 |
| TEGO ® ViscoPlus 3030(thicker) | 0.8 |
| HEC ER5200(thicker) | 1.8 |
| AMP-95 (pH modifier) | 2.1 |

At a temperature of 23° C. and a relative humidity of 50%, water-borne coatings 3 is sprayed in an amount of 0.82 kg/m² onto a colored steel plate (coated with polyester), and cured by self-crosslinking under environmental conditions to obtain a white bottom coating having a dry film thickness of 400 μm; at a temperature of 23° C. and a relative humidity of 50%, water-borne coatings 7 is sprayed in an amount of 0.28 kg/m² onto the white bottom coating, and UV cured under environmental conditions to obtain a bottle green top coating having a dry film thickness of 100 μm; thus obtaining comparative coating system 2.

### Properties Testing

Coating systems 1 to 3 and comparative coating systems 1 to 2 are tested according to above mentioned standards, and results obtained are shown below in table 8.

TABLE 8
main physical properties of coating systems 1 to 3 and comparative coating systems 1 to 2

| | coating | | coating | | coating | | comparative coating | | comparative coating | |
|---|---|---|---|---|---|---|---|---|---|---|
| | system 1 | | system 2 | | system 3 | | system 1 | | system 2 | |
| total solar radiation | 44% | | 26% | | 26% | | 12% | | 8% | |
| reflectivity | | | | | | | | | | |
| water impermeability | qualified^{c} | | qualified | | qualified | | qualified | | qualified | |
| adhesion to colored steel | 800 | N/m | 800 | N/m | 260 | N/m | /^{d} | | / | |
| plate | | | | | | | | | | |
| stain resistance | grade 2 | | grade 2 | | grade 2 | | grade 4 | | grade 2 | |
| accelerated aging under | 1000 | h | 1000 | h | 1000 | h | 1000 | h | 1000 | h |
| xenon lamp | | | | | | | | | | |

white reflective and water-proof layer or white bottom coating

| | | | | | | | | | | |
|---|---|---|---|---|---|---|---|---|---|---|
| tensile strength | 3 | MPa | 3.2 | MPa | 3 | MPa | 3 | MPa | 3.2 | MPa |

| | | | | | |
|---|---|---|---|---|---|
| elongation at break | 200% | 180% | 200% | 200% | 180% |

decorative and reflective layer or top coating

| | | | | | | | | | | |
|---|---|---|---|---|---|---|---|---|---|---|
| tensile strength | 3 | MPa | 3.5 | MPa | 3.5 | MPa | 3 | MPa | 3.5 | MPa |

| | | | | | |
|---|---|---|---|---|---|
| elongation at break | 200% | 150% | 150% | 200% | 150% |

^{c}The result that no water penetrate through under an applied pressure of 0.3 MPa within 0.5 hour is recorded as qualified.
^{d}“/” means no tests is conducted thereon.

1. A water-proof coating system for reflecting solar radiation, said coating system comprises:
optionally a base layer on a substrate and a reinforcing layer on the base layer;
a white reflective and water-proof layer on the substrate or on the reinforcing layer; and
a decorative and reflective layer on the white reflective and water-proof layer; wherein the decorative and reflective layer comprises colored infrared-reflective pigments.

2. The coating system according to claim 1, wherein the colored infrared-reflective pigments are selected from the group consisting of chrome iron oxides, cobalt aluminum oxides, cobalt chrome aluminum oxides, manganese antimony titanium oxides, iron zinc titanium oxides, iron aluminum titanium oxides, chrome antimony titanium oxides, nickel antimony titanium oxides, cobalt chrome zinc titanium oxides, cobalt nickel zinc titanium oxides, iron chrome zinc titanium oxides and cobalt chrome magnesium zinc aluminium oxides.

3. The coating system according to claim 1, wherein the decorative and reflective layer is formed from water-borne coatings comprising acrylic polymers and UV cross-linking agents.

4. The coating system according to claim 3, wherein the acrylic polymers are C1-8 alkyl acrylate/C1-8 alkyl acrylate copolymers, C1-8 alkyl methacrylate/C1-8 alkyl methacrylate copolymers, C1-8 alkyl acrylate/styrene copolymers, C1-8 alkyl methacrylate/styrene copolymers, C1-8 alkyl acrylate/C1-8 alkyl methacrylate/styrene copolymers or mixtures thereof.

5. The coating system according to claim 3, wherein the UV cross-linking agents are benzophenone, benzophenones substituted by C1-3 alkyl or mixtures thereof.

6. The coating system according to claim 3, wherein the UV cross-linking agents are 0.1 to 2% by weight based on the total weight of the water-borne coatings.

7. The coating system according to claim 1, wherein the white reflective and water-proof layer comprises white infrared-reflective pigments selected from the group consisting of titanium dioxide, zinc oxide and zinc sulfide.

8. The coating system according to claim 7, wherein the white reflective and water-proof layer comprises rutile titanium dioxide as the white infrared-reflective pigments.

9. The coating system according to claim 7, wherein the white infrared-reflective pigments are 1 to 50% by weight based on the white reflective and water-proof layer.

10. The coating system according to claim 1, wherein the white reflective and water-proof layer is formed from water-borne coatings comprising acrylic polymers.

11. The coating system according to claim 10, wherein the acrylic polymers are C1-8 alkyl acrylate/C1-8 alkyl acrylate copolymers, C1-8 alkyl methacrylate/C1-8 alkyl methacrylate copolymers, C1-8 alkyl acrylate/styrene copolymers, C1-8 alkyl methacrylate/styrene copolymers, C1-8 alkyl acrylate/C1-8 alkyl methacrylate/styrene copolymers or mixtures thereof.

12. The coating system according to claim 1, wherein the decorative and reflective layer has a dry film thickness of 0.02 to 0.3 mm.

13. The coating system according to claim 1, wherein the decorative and reflective layer has a tensile strength of 1 to 4 MPa, and an elongation at break of 100 to 400%.

14. The coating system according to claim 1, wherein the white reflective and water-proof layer has a dry film thickness of 0.2 to 1.5 mm.

15. The coating system according to claim 1, wherein the white reflective and water-proof layer has a tensile strength of 1 to 4 MPa, and an elongation at break of 100 to 400%.

16. The coating system according to claim 1, wherein the reinforcing layer is non-woven fabrics of synthetic material fiber, glass fiber or combination thereof.

17. The coating system according to claim 1, wherein the base layer is made up by a same material as that of the white reflective and water-proof layer.

18. The coating system according to claim 1, wherein the substrate is metal substrate, colored steel plate, concrete, asphaltic substrate or PVC substrate.

19. Water-borne coatings for forming a decorative and reflective layer in a coating system, said water-borne coatings comprising:
acrylic polymers;
colored infrared-reflective pigments; and
UV cross-linking agents.

20. The water-borne coatings according to claim 19, wherein the acrylic polymers are C1-8 alkyl acrylate/C1-8 alkyl acrylate copolymers, C1-8 alkyl methacrylate/C1-8 alkyl methacrylate copolymers, C1-8 alkyl acrylate/styrene copolymers, C1-8 alkyl methacrylate/styrene copolymers, C1-8 alkyl acrylate/C1-8 alkyl methacrylate/styrene copolymers or mixtures thereof.

21. The water-borne coatings according to claim 19, wherein the acrylic polymers are 20 to 35% by weight based on the total weight of the water-borne coatings.

22. The water-borne coatings according to claim 19, wherein the colored infrared-reflective pigments are selected from the group consisting of chrome iron oxides, cobalt aluminum oxides, cobalt chrome aluminum oxides, manganese antimony titanium oxides, iron zinc titanium oxides, iron aluminum titanium oxides, chrome antimony titanium oxides, nickel antimony titanium oxides, cobalt chrome zinc titanium oxides, cobalt nickel zinc titanium oxides, iron chrome zinc titanium oxides and cobalt chrome magnesium zinc aluminium oxides.

23. The water-borne coatings according to claim 19, wherein the UV cross-linking agents are benzophenone, benzophenones substituted by C1-3 alkyl or mixtures thereof.

24. The water-borne coatings according to claim 19, wherein the UV cross-linking agents are 0.1 to 2% by weight based on the total weight of the water-borne coatings.
